(19) United States
(12) Patent Application Publication
(10) Pub. No.: US 2010/0032358 A1
(43) Pub. Date: Feb. 11, 2010

(54) MODULAR WATER PURIFICATION UNIT

(76) Inventor: Mikkel Vestergaard Frandsen, Lausanne (CH)

Correspondence Address: JAMES C. WRAY, 1493 CHAIN BRIDGE ROAD, SUITE 300, MCLEAN, VA, 22101, US

(21) Appl. No.: 12/448,078

(22) PCT Filed: Dec. 6, 2007
(86) PCT No.: PCT/DK2007/000531

§ 371 Date: Jul. 16, 2009

(51) Int. Cl. C02F 9/12; C02F 1/28; B29C 70/80; C02F 1/32; C02F 1/68

(52) U.S. Cl. 210/202; 210/232; 264/268

(57) ABSTRACT

A portable water purification unit in the form of a stiff, tubular housing with a first opening at a first end for entrance of water into the tubular housing and a mouthpiece at an opposite end. The tubular housing comprises at least a first module and a connected second tubular module containing mutually different water purifying granular resins. The first module or the second module have at least one water permeable mesh with a mesh size smaller than the grain size of the resins for preventing mixing of the resins.

### FIELD OF THE INVENTION

The present invention relates to a portable, tubular water purification units through which water is sucked by the mouth.

### BACKGROUND OF THE INVENTION

Large parts of the world are without clean drinking water, which has resulted in an increased focus on low cost water supplies. One solution is water dispensers, where people by delivery get access to clean water. Another solution is based on portable water purification systems, for example, as in the form of the commercially available product with the name LifeStraw®.

Despite the popularity and versatility of LifeStraw®, there is an on-going demand for improvement in order to cope with the demand of providing a low cost apparatus with high water purification efficiency and with the capability to be adaptable to the actual applications, which may vary in dependence of the region in which such a water purification unit is applied.

### DESCRIPTION/SUMMARY OF THE INVENTION

It is therefore the object of the invention to provide a water purification device with a high degree of flexibility with respect to customization for specific needs.

This purpose is achieved with a portable water purification unit in the form of a tubular housing, preferably stiff housing with a length of less than 50 cm and a width of less than 80 mm, the tubular housing having a first opening at a first end for entrance of water into the tubular housing and a mouthpiece at an opposite end for suction of water through the tubular housing, the mouthpiece having a narrowing part towards the opposite end and configured for fitting to a human mouth. The tubular housing comprises a first module and a second module, and optionally further modules, containing mutually different water purifying granular resins. The first module has a first connector and the second module has a second connector, both modules are tubular and connected for confining water flowing through modules. The first module or the second module or both have at least one water permeable mesh with a mesh size smaller than the grain size of the resins for preventing mixing of the resins.

The modular concept of a water purification unit according to the invention makes the product easier and more reliable in manufacturing and makes it easy to customize for specific needs. For example, according to the needs for purifying water, different combinations of modules may be chosen in dependence of the water impurities that are desired to be removed. If arsenic is to be removed, a special module or a number of special modules may be connected containing resins that are used for arsenic removal. In addition, special modules may be provided with additive agents, such as vitamins, fluorine or other beneficial agents.

In a preferred embodiment, those modules, which contain a granular resin or has a pre-filter function, contain a mesh at one of their ends. After filling of a module with a granular media, the module will be closed with the mesh of the next module, welded or glued on top. The last chamber will normally be closed by a ring shaped module.

Certain modules may be used without an integrated mesh at the end of the module, for example modules containing hollow fibres or modules containing filters with nanofibres, such as Nanoceram® which is commercially available from the company Argonide®. The important feature is that all modules have the same connectivity, so that they can be stacked up together is a systematic way with all other parts, for example in order to provide a concept matching the Lifestraw principle.

For example, cylindrical plastic modules of identical outer diameters, but variable length may be stacked in extension of each other and mounted together, to form a tube with a, preferably constant, outer diameter. In a further embodiment, the modules comprise connectors that are screw connectors, snap fit connectors, or conical bushings. Preferably, the outer side of the modules constitutes the outer surface of the tubular housing. However, it is also possible that the modules may be fitted inside an outer tubular housing. The modules may be detachably mounted together, though for safety reasons, it is preferred that the modules are non-detachably mounted successively together, for example by ultrasonic welding or glueing or other types of welding process. The invention is suited for compact water purification devices inline with the afore-mentioned product LifeStraw®.

In a further embodiment, a mesh is an integrated part of the tubular module. For example, a mesh is moulded to one end or to both ends of a tubular part of the module. In a further embodiment, each of these cylindrical modules are injection moulded and are closed at one end by a mesh, preferably textile mesh. In a certain production method, this mesh comes as a band and is guided into an injection mould. The mould closes, the polymer is injected, and the mesh will be “overmoulded”. The mould opens, the overstanding mesh is automatically cut off, and module is ready for filling. After having filled the dedicated media in each module/cartridge, it is closed by the mesh of the next module, which is stacked on top of the preceding module.

By the overmoulding, the mesh and the tubular plastic body is created as one piece that cannot be separated without destroying the module, which is a safety factor preventing inappropriate modifications of the water purifying unit according to the invention.

Meshes at the ends of the modules may be textile meshes. In this connection, it is important to notice that the risk of bacteria growth within the mesh is higher than on the plastic surface, because there are pockets between the yarns where bacteria may grow. In order to prevent bacteria growth inside the meshes, the meshes may be provided with an antimicrobial agent to prevent growth of bacteria, virus and other microbes on or in the mesh. This antimicrobial agent may be provided as a surface treatment, such as an impregnation of the mesh, or as en incorporation of the agent in the material of the mesh, where the incorporated agent is capable of migrating to the surface of the mesh material for prolonged antimicrobial action.

The assembled modules of a unit according to the invention may form a housing in combination. Alternatively, though not preferred, the modules may fit into an outer tube which acts as the outer part of the housing. In a further embodiment, at least part of the housing or part of the mouthpiece or at least parts of both have an antimicrobial surface. If the mouthpiece, or at least part of it, preferably that part that is provided for contact with the mouth of a person drinking from the mouthpiece, has an antimicrobial surface, the bacteria from one person drinking from the mouthpiece are killed on contact, such that a second person using the mouthpiece is not infected. If the housing, or at least part of the housing, preferably that part of the housing that is configured for hand contact with the housing, has an antimicrobial surface, the bacteria from one person holding the housing are killed on contact, such that the second person touching the housing is not infected.

One example of providing the antimicrobial surface is by coating with an antimicrobial substance. A large number of different coatings are available. Examples of antimicrobial organosilane coatings are disclosed in U.S. Pat. No. 6,762,172, U.S. Pat. No. 6,632,805, U.S. Pat. No. 6,469,120, U.S. Pat. No. 6,120,587, U.S. Pat. No. 5,959,014, U.S. Pat. No. 5,954,869, U.S. Pat. No. 6,113,815, U.S. Pat. No. 6,712,121, U.S. Pat. No. 6,528,472, and U.S. Pat. No. 4,282,366.

Another possibility is an antimicrobial coating that contains silver, for example in the form of colloidal silver. Colloidal silver comprising silver nanoparticles (1 nm to 100 nm) can be suspended in a matrix. For example, the silver colloids can be released from minerals such as zeolites, which have an open porous structure. Silver can also be embedded in a matrix such as a polymer surface film. Alternatively, it may be embedded in the matrix of the entire polymer during plastic forming processes, typically known as injection moulding, extrusion or blow moulding.

A silver containing ceramic is disclosed in U.S. Pat. No. 6,924,325 by Qian. Silver for water treatment is disclosed in U.S. Pat. No. 6,827,874 by Souter et al, U.S. Pat. No. 6,551,609 by King, and it is known in general to use silver enhanced granular carbon for water purification. Silver coating for water tanks is disclosed in European patent application EP1647527.

Other antimicrobial metals are copper and zinc, which, alternatively or in addition, may be incorporated in an antimicrobial coating. An antimicrobial coating containing silver and other metals is disclosed in U.S. Pat. No. 4,906,466 by Edwards and references therein.

A coating may, in addition or alternatively, comprise titanium dioxide. Titanium dioxide can be applied as a thin film that is synthesized by sol-gel methods. As anatase TiO₂ is a photo catalyst, thin films with titanium dioxide are useful on external surfaces that are exposed to UV and ambient light. Also, nanocrystals of titanium dioxide may be embedded within polymers. In addition, silver nanoparticles can be complexed with titanium dioxide for enhanced effectiveness.

For example, a thin film coating may have a thickness as little as a few micrometer. A coating may in addition, or alternatively, comprise a reactive silane quaternary ammonium compound, like it is known from the company AEGIS® under the trademark Microbe Shield™ used for air conditioning. When applied as a liquid to a material, the active ingredient in the AEGIS Antimicrobial forms a colourless, odourless, positively charged polymer coating, which chemically bonds & is virtually irremovable from the treated surface.

Some antimicrobial substances are able to migrate through polymer matrices. This implies that a polymer coating may contain antimicrobial substances that are continuously renewed due to the migration from the inside of the coating to the surface of the coating. A material with this property is suited as a material for the mesh and, also, for the tubular part of the modules.

In a further embodiment, the material of the mouthpiece, or part of the material, preferably that part that is provided for contact with the mouth of a person drinking from the mouthpiece, is made of a material containing an antimicrobial substance. Additionally or alternatively, the housing, or at least part of the housing, preferably that part of the housing that is configured for hand contact with the housing, is made of a material containing an antimicrobial substance.

This antimicrobial substance has the property to migrate from inside the material to the surface of the material. In case that the housing is made of such a material, the bactericide may also migrate to the inner surface inside the housing. Depending of the technology of coating, an inner surface coating can also be achieved by dipping into a bath, resulting in both the inner surface as well as the outer surface being treated with an antimicrobial agent. If only the inner surface or only the outer surface should be treated, or if the treatment of the inner surface or the outer surface is different, processes like spraying may be applied of the respective dedicated surface or surfaces. Alternatively, the housing may comprise an inner layer that is made of such a material for migration of the antimicrobial substance to the inner surface of the housing. This implies that the liquid, preferably water, inside the housing is bactericidally treated as well. This is a very important issue as explained in more detail in the following.

Some water purification devices are functioning due to chemical treatment of the water flowing through an internal filter. However, as disclosed in U.S. Pat. No. 5,045,198, U.S. Pat. No. 5,705,067, and International patent application WO 93/02781 and WO 2004/050205, hollow fibres as filters may be employed to block microbes from traversing the filter, which to a large extent substitutes a chemical treatment. If no precaution is taken, such filters may be subject for bacteria growth inside the filter, which implies a health risk if a microbial leak occurs through the hollow fibres. Therefore, bacteriostatic fibres may be used. According to the invention, the migration of the antimicrobial substance through the material and to the inner surface of the material may be used in connection with hollow fibre filtering or on a general basis for reducing the content of microbes inside the dispenser or purifier according to the invention. An antimicrobial coating of the hollow fibres themselves may possibly be omitted in this case.

An antimicrobial inner coating may as well be an option in connection with the invention when applying filters using nanofibres in a matrix, such as described in European patent EP1401571, U.S. Pat. No. 6,838,005, or commercially available under the trade name Nanoceram® from the company Argonide®.

Thus, by making the unit according to the invention of a material with a migrating antimicrobial agent, infections from the inside as well as from the outside of the device are prevented. Additionally, also the meshes inside the housing are treated with an antimicrobial agent.

In a certain embodiment, the purifier may be provided with a mouthpiece and a housing that may have antimicrobial surfaces, which are antimicrobially identical. However, they may alternatively be different. Also, the inside of the housing may be antimicrobially different from the outside of the housing. This may be of advantage, if the microbes inside the housing are of different nature than outside the housing. For example, the housing or the mouthpiece, or both may be made of a polymer having a first bactericidal substance incorporated or impregnated for migration to the surface. In addition, the inside or the outside may have a second or even further bactericides integrated, impregnated or coated thereon in order to match the bactericidal effect to the demands for efficiency, for example in order to achieve a synergistic effect. In this connection, a synergist like PBO may be incorporated as well or as an alternative to a second bactericide.

The antimicrobial agent may be incorporated in the material during production, for example by blending the agent into a polymer material before casting or extrusion of the polymer. Alternatively, the antimicrobial agent may be impregnated into the material, for example by diffusion into the material at elevated temperature. As an even further alternative method, the material may be provided as a layered material, for example in the form of a laminate, where a reservoir is provided between an inner and an outer layer, the reservoir containing an antimicrobial agent capable of migrating through the outer layer and, optionally, also through the inner layer in order to provide the agent on the outer surface of the housing and/or mouthpiece and, optionally, also on the inner surface of the housing.

A further possible method for achieving a surface coating is molecular vapour deposition MVD, possibly on a polymer surface which has been activated by ultra violet illumination and ozone exposure or exposure to an oxygen plasma.

Arsenic is a naturally occurring contaminant found in a large number of ground waters, particularly in Bangladesh and in a number of states in the US. Being without odour and taste, no warnings are typically recognised during consumption of water containing arsenic. Especially in Bangladesh, many people are suffering from chronic poisoning appearing with painful, disturbed skin pigmentation and calluses on the palms and the hands. For example, according to www.sos-arsenic.net, in India, 48.7% water samples had arsenic concentration above 10 ppb and 23.8% above 50 ppb. In Bangladesh, these values were 43.0% and 31.0% respectively. Almost 9 million people in India were drinking water with more than 10 ppb arsenic and 7 million people with more than 50 ppb arsenic. These facts have resulted in an increased focus on low cost but efficient means for arsenic removal from ground water.

Typical removal of arsenic from water implies ferric and aluminium oxides. Companies such as Alcan®, Adedge® and Kemira® have developed systems with resins containing such oxides for arsenic removal.

Normally, arsenic occurs in water in trivalent form and in pentavalent form, where the trivalent Arsenite As⁺³ form is regarded as more toxic, whereas the pentavalent Arsenate form As⁺⁵ is easier to remove. Therefore, As⁺³ is oxidised to As⁺⁵ in conventional processes in order to remove the entire As content to below certain levels, typically to less than 10 micrograms per litre corresponding to 10 ppb (parts per billion).

A system for As removal from ground water is disclosed in U.S. Pat. No. 6,461,535 by de Esparza. In this case, clay, a coagulant, such as ferric chloride and aluminium sulphate, and an oxidizer, such as calcium hypochlorite are used for absorbing the arsenic into the coagulated colloidal mixture. In order for the clay to settle down in the water before the use of the water, a waiting time of 15-20 minutes is necessary.

A different system is disclosed in European patent application EP 1 568 660 for removing As with a strong base anion exchange resin comprising at least one metal ion or metal-containing ion whose arsenate salt has a Kₛₚ no greater than 10⁻⁵.

In rural areas, where clean drinking water is scarce, the above mentioned commercially available water purification suction unit LifeStraw® has achieved increased popularity. The unit, being used for water filtration by sucking water from the water source directly through the unit and into the mouth, is compact and measures with its mouthpiece only 25 cm in length and 2.9 cm in width. It acts instantaneous in order for the water sucked through the unit to be safe for human consumption. The unit contains a specially developed halogen-based resin that is extraordinarily effective to kill bacteria such as Shigella, Salmonella, Enterrococcus, Staphylococcus Aureus and E. Coli, on contact, textile pre-filters to remove particles larger than 6 microns, and activated carbon to withhold excessive iodine, bad smell and taste. This unit efficiently removes disease causing micro-organisms which spread diarrhoea, dysentery, typhoid, and cholera. In spite of having a number of advantages such as the ability to almost instantaneously clean the water, the light weight, the portable construction and the low cost of the device making it suitable for distribution in poor regions, it is however not useful for removing arsenide from the water.

In a further embodiment, the water purification unit according to the invention has a number of compartments in modules for water flow successively through these modules, the unit comprising:
a compartment with an iodine releasing resin for killing microbes in water
a downstream compartment with an iodine scavenger, the iodine scavenger being configured for releasing chlorine during iodine scavenging, the amount of released chlorine being configured for oxidation of trivalent arsenide to pentavalent arsenide,
a further downstream compartment with a arsenide removal resin configured for removal of arsenide from the water.

With a purification unit according to the invention in the LifeStraw® format, a compact and customizable device is provided, for not only cleaning water on a general basis but also for removing arsenic. The compact property is achieved by using the chlorine—which in LifeStraw® is a waste product—for successful oxidation of arsenic in order to facilitate removal of arsenic. Thus, no additional substances are required for oxidising arsenic, which is in contrast to prior art techniques, where a variety of substances are added for the oxidation of arsenide. Thus, the invention utilises a combination of knowledge from entirely different fields, namely the know-how of cleaning water in primarily poor tropical countries with compact, portable units like LifeStraw® and the know-how of arsenic removal in modern household apparatuses or larger facilities.

It should be acknowledged that the invention by involving low cost makes it possible for economically poor regions not only to get access to biologically cleaned water but also access to arsenic free water at the same time. The LifeStraw® product is already experiencing increased popularity in remote regions with difficult access to clean water, and an extended LifeStraw® product with arsenic removal capabilities would not imply much higher costs for the end user.

By the invention, both ion exchange and activated carbon can be used, as it will become apparent in the following, at costs and compactness that does not prevent access to clean water in remote dwellings and in even very poor regions. Thereby, spreading of diseases following bad drinking water can be drastically reduced, especially if governments and non-governmental organisations support the distribution of such compact devices among people in poor regions.

However, it should be noted that application of the invention is not limited to poor and remote regions but may be used in a variety of other applications. For example, due to its compactness, it is suited for general outdoor activities as well. Especially in US mountainous regions, where water appears clean at first sight and suitable for drinking, but contains the odourless, tasteless and dangerous arsenic, the user may be sure that the light weight, portable unit, such as an extended, arsenic removing LifeStraw®, prevents later suffering from arsenic induced illness due to the double function of the invention, where biological and chemical cleaning is performed at the same time at a degree which makes direct drinking through a unit according to the invention possible.

In a preferred embodiment, the iodine scavenger resin is a strong ion exchange resin, for example a strong base anion exchange resin. Choosing such a resin promotes the compactness of the unit. It is well known to use activated carbon for iodine removal. However, this substance is not as efficient as strong ion exchange resins and rather large quantities are required. In order to achieve a compact unit, especially in the case of the LifeStraw® product, a strong base anion exchange resin has been investigated instead. The use of this resin, as described above, opens the possibility for arsenic oxidation without loosing compactness.

One possibility is an arsenic removing resin that comprises activated alumina, for example as known from the commercially available Alcan® resin named AAFS50™. Alternatively, the arsenic removing resin comprises ferric oxide, for example as known from the commercial Adedge® resins named AD33R™ or AD33L™. As a further alternative, Kemira CPH 0180, known as a ferric oxide with very high Arsenic absorption capacity may be used. These commercially available resins contain substances for arsenic oxidation themselves. Thus in case the invention is used together with these commercial resins, the chlorine oxidation of As(III) to As(V) may be used to reduce the amount of these commercial resins, so that primarily the As(V) removal property is utilised. A reduction of the amount of such commercial resins is of high interest due to the substantial costs of these resins. For this reason also, a thin layer of ferric oxide, possibly enriched with or substituted by aluminium oxide, is considered as a useful solution.

The iodine needs to be active for a certain time in order to achieve a good result with respect to biological cleaning. The active time depends on the flow from the iodine releasing resin to the iodine scavenger. In the case of LifeStraw®, where water is sucked directly through the compact unit by the mouth for drinking from a contaminated water source, the activation time may necessarily be extended, which can be achieved by including a void space between the iodine releasing resin and the iodine scavenger resin. The volume of the void space should in this case be chosen to provide a substantial extension of the reaction time between the iodine and water contaminants during the water flow through the volume typical for the device when sucked by the mouth. The term “substantial extension” covers an extension of the flow time which, typically, is in order of the flow time through the iodine releasing resin compartment. Thus, the void space may have a volume comparable to the volume of the compartment with the iodine releasing resin. For the LifeStraw product, the flow rate is 100-150 ml/minute, which is also feasible for the invention in the case of a comparable design.

In addition to removing excess chlorine and other taste or odour properties from the cleaned water, a compartment may optionally be provided with activated carbon for iodine removal, for example in the form of granular activated carbon (GAC). Optionally, the GAC may be silver loaded.

The activated carbon may be used downstream of the iodine scavenging resin. This configuration has the advantage that the scavenging resin primarily takes up the iodine and correspondingly releases chlorine for the arsenic oxidation, for example in the form of hypochlorite with a large amount of active chlorine. Alternatively, the activated carbon is mixed with the iodine scavenger resin. In this case, the activated carbon takes up part of the iodine without release of chlorine. Thus, by mixing activated carbon, which is able to take up iodine without release of chlorine, and the iodine scavenger resin that is able to release chlorine as a result of the uptake of iodine, a desired ratio between the uptake of iodine and the release of chlorine may be achieved in accordance with predetermined amounts necessary for a proper arsenic oxidation on the one hand and a long term, low cost functioning of the device on the other hand, securing sufficient iodine release and removal.

As activated carbon also takes up chlorine, it has to be ensured that the chlorine is in the water for a time sufficient enough to assure a proper conversion of As(III) to As(V). Therefore, it is preferred to provide the activated carbon upstream of the arsenic removing compartment.

The invention in the form of a water purification unit with or without arsenic removal function can be employed in a number of physical embodiments. However, the preferred solution utilising the potential for high compactness is a portable water purification unit, for example tubular as the LifeStraw® product. In order to be carried around, the unit is advantageously shorter than 40 cm, or even shorter than 35 cm. For example, LifeStraw® has a length of 25 cm, a width of 2.9 cm, and a dry weight of 95 grams. Accordingly, the unit in the portable embodiment is preferred to have a diameter of less than 50 mm, rather less than 40 mm. Such a tube may be provided with a mouthpiece for sucking water through the unit, just like LifeStraw®.

The amount and efficiency of the iodine releasing resin should be adjusted to achieve a certain arsenic removal, for example down to a level of less than 10 ppb. The amount of resin necessary to achieve this is dependent on the arsenic content in the water, and the final arsenic level to be achieved. Thus, the unit according to the invention may be configured to release a certain amount of iodine in the water; the amount and efficiency of the iodine scavenger resin may then be configured—in dependence of the certain amount of iodine—to release a certain amount of active chlorine in the water; this certain amount of active chlorine is configured for oxidation of a substantial amount of arsenide. For safety reasons, despite a possibly low amount of arsenic, the resin may be configured for secure working also at high contents of arsenic, for example of the order of up to 1000 or 2000 parts per billion. In comparison, it may be mentioned that the level of arsenic in many water sources in Bangladesh is 1200 ppb exceeding by far the admissible limit of 50 ppb for the Bangladesh drinking water.

The unit according to the invention may use the aforementioned removal of arsenic as a pre-stage for a second removal stage. For example, the iodine scavenger may release sufficient chlorine to remove more than 50% of the arsenic, for example 99% or even 99.9% of it. Whereas in a second stage, for example, comprising the aforementioned AD33 from Adedge® or AFSS50 from Alcan®, the remaining arsenic content may be removed to a very low degree.

A multiple stage arrangement may be useful in the case where a first product is used for removing the first part of arsenic, for example 95%, and the second stage is used to reduce the content to a very low degree. The reason for using two stage removal system could be that the first product is by far cheaper than the second product. Thus, a low cost first stage may be used for removing the first coarse arsenic content, whereas the second, more expensive stage may be used to remove the last part of the arsenic below a predetermined level, such as 10 ppb.

For example, it has been disclosed in Shaban W. Al Rmalli et al. “A biomaterial based approach for arsenic removal from water” published in J. Environ. Monit., 2005, 7, 279-282 that biological material can be used for arsenic removal. Biological material such as dried roots of the water hyacinth plant (Eichhornia crassipes) can remove arsenic from water. In the article, examples are given for 96% arsenic removal. Though the removal speed was rather slow, namely 30 minutes for 80% removal and 60 minutes for 96% removal of arsenic, the results are promising and have a potential for improvement of the arsenic removal properties. Such low cost, biological material may be considered as a candidate for a first stage of arsenic removal as discussed above.

Further interesting material for arsenic removal is available from the US company VeeTech, P.C. under the commercial names G2 and HIX. These products may be candidates for a single step arsenic removal or in a two stage arsenic removal system according to the invention.

Whether only one stage is used or two or more stages for arsenic removal are used, the aim is to reduce the arsenic to a very low level, for example the Internationally recognised lower level of 10 parts per billion.

In order to leave an impression of the relative amounts of resins in the unit according to the invention, the following typical numbers are helpful. Thus, the amount of iodine releasing resin is, typically, between 5 and 30%, preferably between 15 and 25%, of the inner volume of the unit. The amount of iodine scavenger resin is, typically, between 5 and 40%, preferably, between 20 and 30% of the inner volume of the unit. The amount of arsenic removing resin is, typically, between 5 and 50% of the inner volume of the unit. If present, the amount of activated carbon is, typically, between 20 and 40% of the inner volume of the unit.

In comparison with the LifeStraw® product, a preferred water purification unit according to the invention is a portable, modular unit with an antimicrobial mouthpiece for sucking water through the unit, the length of the unit is less than 40 cm, and the diameter is less than 50 mm. The amount of iodine releasing resin is between 5 and 50% of the inner volume of the unit, the amount of iodine scavenger resin is between 5 and 50% of the inner volume of the unit, and the amount of arsenic removing resin is between 5 and 50% of the inner volume of the unit.

In a further preferred solution, the water purification unit has a length of around 25 cm and a diameter of around 30 mm. The amount of iodine releasing resin is between 10 and 30% of the inner volume of the unit, the iodine scavenger resin is a strong base anion exchange resin with a volume between 10 and 30% of the inner volume of the unit, and the arsenic removing resin is AD33 or AAFS50 or a mixture of AD33 or AAFS50 with a volume of between 5 and 50% of the inner volume of the unit. In addition, the purification unit may comprise a compartment with activated carbon for iodine removal. The amount of activated carbon is between 5 and 50%, or rather between 20 and 40% of the inner volume of the unit. The carbon may be silver loaded.

As iodine releasing resin, a number of products are on the market as well as for the iodine scavenger. Promising results for iodine removal have been achieved by using Dowex™ Marathon™ A produced by Dow Chemical, for example, in combination with granular activated carbon as a subsequent step.

An additional cleaning option that may be incorporated in the unit according to the invention is an ultra violet (UV) lamp, for example as it is disclosed in US patent application No. 2005/258108. Such a lamp may be used in addition to the above means for cleaning the water. For example, the UV LED (Light Emitting Diode) lamp may be used for disinfection under those circumstances where the chemistry in the unit is not sufficient. Thus, with relatively little chemistry inside the unit, the unit may still be able to perform satisfactorily, even when the contamination suddenly overshoots expectations for contamination levels.

An on-off procedure of a UV LED requires some means for measuring the actual contamination level or means for registering the lack of total removal of contaminants. The latter may be performed with an electronic circuit, the conduction through which is governed by the contamination. In this case, the amount of ions present in the water due to released cleaning agents has to be taken into regard. However, after the GAC section, the water would be clean, and a high conduction in the water would indicate an unsatisfactory cleaning.

An electronic circuit in the water purification unit, for example at the exit side, may as well be used for indicating whether the cleaning process is satisfactory within predetermined levels on a general basis. For example, a small electronic circuit and a battery or solar cell may be used to illuminate a lamp or to change colour of an indicator in order to show missing function, for example when the chemical products are exhausted.

### SHORT DESCRIPTION OF THE DRAWINGS

The invention will be explained in more detail with reference to the drawing, where

FIG. 1 is an illustration comparing the modular system with prior art LifeStraw®,

FIG. 2 illustrates a modular system according to the invention,

FIG. 3 illustrates an extended modular system according to the invention,

FIG. 4 illustrates the modular system in greater detail,

FIG. 5 illustrates an alternative modular system,

FIG. 6 illustrates an embodiment, where the water purification unit is configured for As removal,

FIG. 7 illustrates a further embodiment, where the water purification unit is configured for As removal.

### DETAILED DESCRIPTION/PREFERRED EMBODIMENT

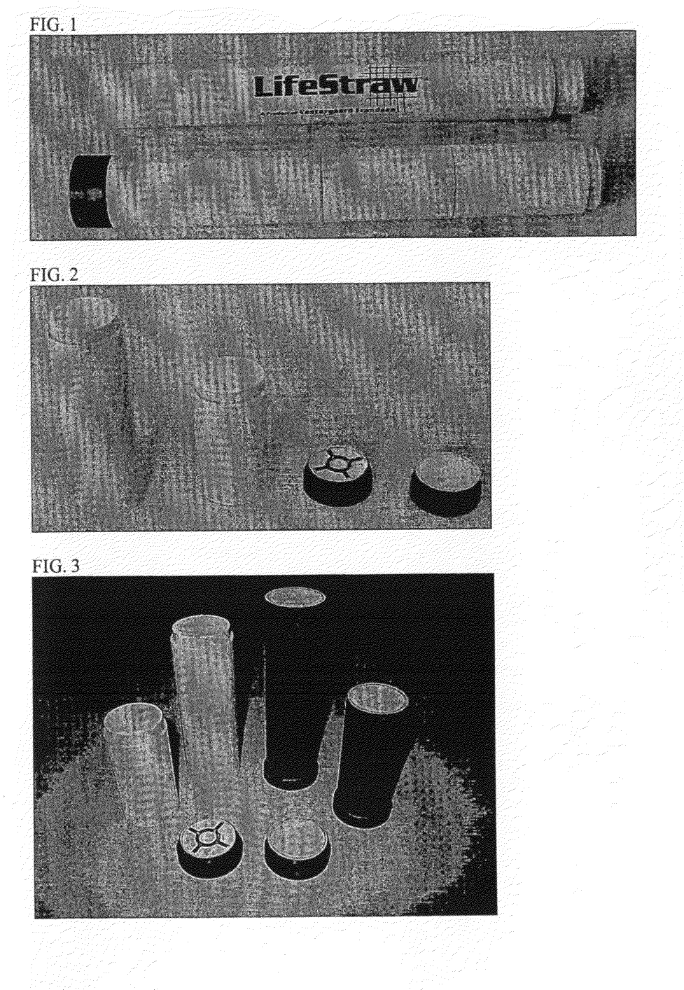

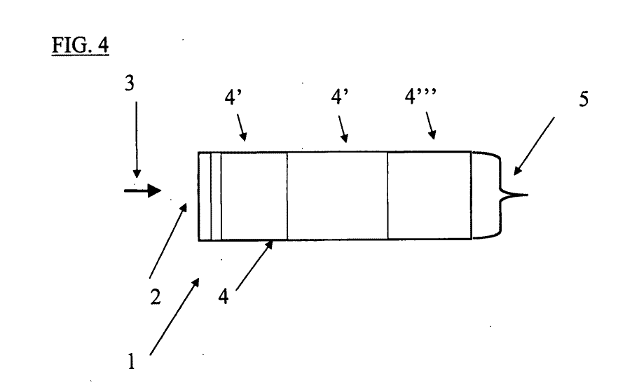

FIG. 1 shows a comparison between the prior art water purifying unit LifeStraw® in the upper part of the image and a modular system according to the invention in the lower part of the invention. It should be noted that both systems are illustrated without mouthpiece. The modular system comprises two filter modules in the left end of the unit which are shown in darker colour and three further modules which are substantially longer. Two of such modules and a coarse filter and a fine filter are shown in greater detail in FIG. 2. The upper ends of the modules are covered with meshes that are welded or glued to the cylindrical module wall. In FIG. 3, the four modules of FIG. 2 are illustrated together with two further modules. The two long, further modules shown with a darker colour are of the kind that can be inserted in a modular configuration into a longer tube that constitutes the main part of the outer housing.

FIG. 4 illustrates a more detailed embodiment of a water purification unit 1 according to the invention. Unit 1 has a housing 4, with three modules 4′, 4″, 4′″, at least two of which contain purification resins. The unit 1 has a water inlet 2 for inlet of a contaminated water flow 3 and a water outlet in the form of a mouthpiece 5 for outflow of clean water. The mouthpiece 5 may be part of the last module 4′″ or be a module in its own. Optionally, the housing 4 and/or the mouthpiece 5 may be provided with an antimicrobial surface.

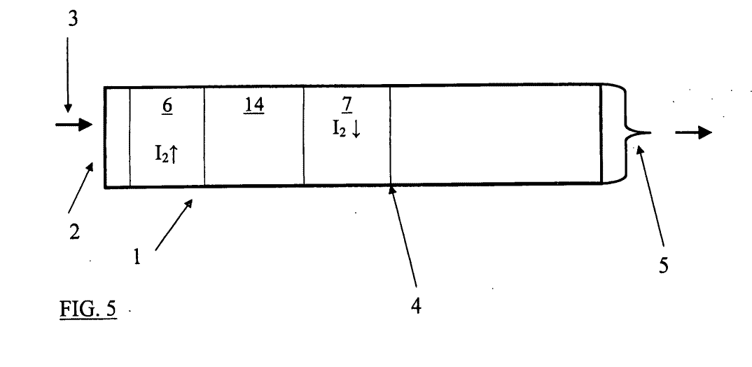

For chemical water treatment, as indicated in FIG. 5, the unit 1 comprises a first module with a compartment 6 with an iodine releasing resin for release of iodine. The iodine is primarily used for killing microbes. Water with iodine flows into a second, downstream module with a compartment 7 with an iodine removing resin, where iodine is removed from the water. The iodine removing resin may be granular activated carbon (GAC), which also removes odour and taste and which is antimicrobial. In order for the iodine to work long enough on the microbes to achieve a proper effect, there may be provided a void space 14 between the iodine resin 6 and the iodine scavenger 7, the size of the void space 14 adjusted relatively to the water flow and the pre-determined necessary reaction time. The void space may be part of the first module or part of the second module or be a module in itself. Additionally, there may be employed other filters inside the housing 4 and compartments with chemical action.

Alternatively or additionally, there may be used narrow fibres for water cleaning by microfiltation, which may be employed by methods and systems, for example, as disclosed in U.S. Pat. No. 5,045,198, U.S. Pat. No. 5,705,067, and International patent application WO 93/02781 and WO 2004/050205.

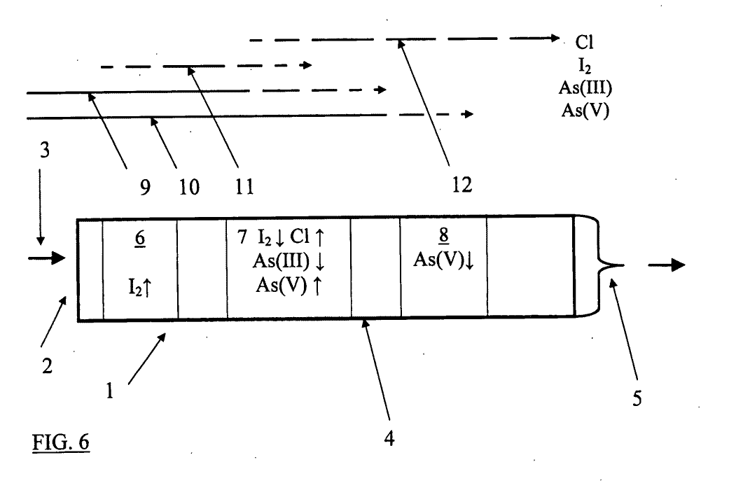

FIG. 6 illustrates a first embodiment of a unit according to the invention. Unit 1 has a water inlet 2 for inlet of a contaminated water flow 3 containing As and a water outlet, 4 for outflow 5 of clean, arsenic-free water. The unit 1 comprises a first module with a first compartment 6 with an iodine releasing resin for release of iodine, which is illustrated by arrow 11. The iodine is primarily used for killing microbes. Water with iodine flows into a downstream module with a compartment 7 with an iodine removing resin, where iodine is removed as illustrated by the stopping of arrow 11 and chlorine released, which is illustrated by arrow 12. The chlorine from compartment 7 oxidizes As(III) to As(V), such that the amount of As(III) is gradually reduced, which is illustrated by the arrow 9. As(V) is removed by the arsenic removal resin in compartment 8, which is illustrated by the arrow 10. Further illustrated in FIG. 3 is a mouthpiece 5 as a water outlet, the mouthpiece 5 may have an antimicrobial surface.

The unit in FIG. 6 may be used for water cleaning and arsenic removal, although FIG. 6 illustrates only the basic principles and may be supplemented with other means to optimize the functioning.

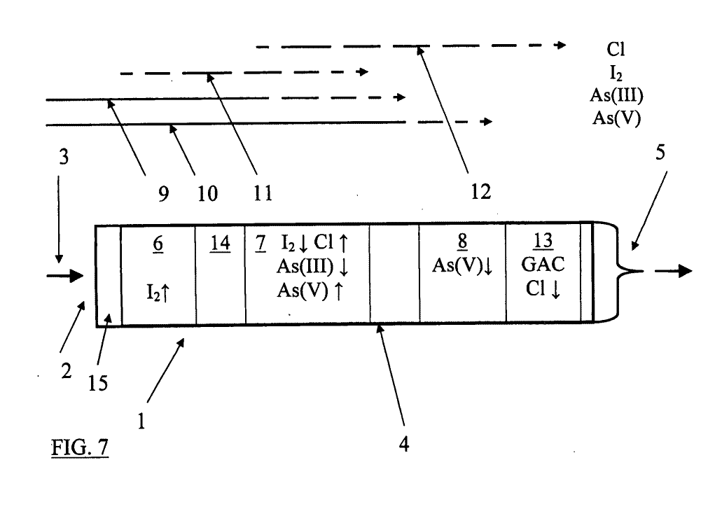

An improved system is illustrated in FIG. 7. For example, the unit 1 may in addition have a chlorine removing compartment 13. The resin in this compartment 13 may be activated carbon in the granular form (GAC), optionally silver loaded. In order for the iodine to work long enough on the microbes to achieve a proper effect, there may be provided a void space 14 between the iodine resin 6 and the iodine scavenger 7, the size of the void space 14 adjusted relatively to the water flow and the predetermined necessary reaction time.

In addition, the water inlet 2 may be followed by a mechanical filter 15 in order to filter away larger particles or microbes. For example, the mechanical filter may be textile filter for removing particles or microbes with a size larger than 6 micrometer, as it is used in the LifeStraw® product.

1. A portable water purification unit in the form of a tubular housing with a length of less than 50 cm and a width of less than 80 mm, the tubular housing having a first opening at a first end for entrance of water into the tubular housing and a mouthpiece at an opposite end for suction of water through the tubular housing, the mouthpiece having a narrowing part towards the opposite end and configured for fitting to a human mouth, wherein the tubular housing comprises at least a first module and a second module containing mutually different water purifying granular resins, the first module having a first connector and the second module having a second connector, the first and the second connector both being tubular and being connected for confining water flowing through the first and the second modules, the first module or the second module or both having at least one water permeable mesh with a mesh size smaller than the grain size of the resins for preventing mixing of the resins.

2. A portable water purification unit according to claim 1, wherein the first module or the second module or both form at least part of the tubular housing.

3. A portable water purification unit according to claim 1, wherein the first module or the second module or both are inserted at least partly into a tubular housing.

4. A portable water purification unit according to claim 1, wherein a mesh is an integrated part of the tubular module.

5. A portable water purification unit according to claim 1, wherein a mesh is moulded to one end or to both ends of a tubular part of the module.

6. A portable water purification unit according to claim 1, wherein the modules are detachably connected to each other.

7. A portable water purification unit according to claim 6, wherein the connectors are screw connectors, snap fit connectors or comprises conical bushings.

8. A portable water purification unit according to claim 1, wherein the unit has a number of successively attached modules to form a tube with approximately constant diameter of less than 5 cm and having a length of less than 40 cm.

9. A portable water purification unit according to claim 1, wherein at least one of the meshes is provided with an antimicrobial agent to prevent growth of bacteria, virus and other microbes on or in the mesh.

10. A portable water purification unit according to claim 1, wherein at least part of the housing or part of the mouthpiece or at least parts of both have an antimicrobial surface.

11. A portable water purification unit according to claim 10, wherein the antimicrobial surface is at least on that part of the surface of the housing, which is configured for hand contact with the housing.

12. A portable water purification unit according to claim 10, wherein the antimicrobial surface is at least on that part of the mouthpiece that is provided for contact with the mouth of a person drinking from the mouthpiece.

13. A portable water purification unit according to claim 11, wherein the antimicrobial surface is provided as an antimicrobial coating with an antimicrobial agent.

14. A portable water purification unit according to claim 9, wherein the antimicrobial coating contains antimicrobial silver.

15. A portable water purification unit according to claim 14, wherein the antimicrobial silver is colloidal.

16. A portable water purification unit according to claim 14, wherein the antimicrobial coating comprises silver releasing zeolites.

17. A portable water purification unit according to claim 13, wherein the antimicrobial surface comprises an antimicrobial organosilane coating.

18. A portable water purification unit according to claim 9, wherein the antimicrobial agent comprises titanium dioxide.

19. A portable water purification unit according to claim 18, wherein the antimicrobial agent comprises nanocrystals of titanium dioxide embedded in a polymer matrix.

20. A portable water purification unit according to claim 18, wherein the antimicrobial coating comprises silver nanoparticles complexed with titanium dioxide.

21. A portable water purification unit according to claim 9, wherein the antimicrobial agent comprises copper.

22. A portable water purification unit according to claim 9, wherein the antimicrobial agent comprises zinc.

23. A portable water purification unit according to claim 1, wherein at least part of the housing or at least part of the mouthpiece or at least part of the meshes are made of a material with an antimicrobial agent inside the material, the antimicrobial agent being configured for migration from the inside of the material to the surface of the material.

24. A portable water purification unit according to claim 23, wherein the antimicrobial agent is impregnated into the material.

25. A portable water purification unit according to claim 23, wherein the antimicrobial agent is incorporated in the material.

26. A portable water purification unit according to claim 23, wherein the material of the mouthpiece or the material of the tubular housing or the material of both is provided as a layered material, where a reservoir is provided between an inner and an outer layer, the reservoir containing an antimicrobial agent capable of migrating through the outer layer.

27. A portable water purification unit according to claim 26, wherein the antimicrobial agent also is capable of migrating through the inner layer for providing antimicrobial agent inside the housing.

28. A portable water purification unit according to claim 26, wherein the material is provided in the form of a laminate.

29. A portable water purification unit according to claim 1, wherein the water purification unit comprises microporous hollow fibers for blocking microbes for traversing unit.

30. A portable water purification unit according to claim 29, wherein the hollow fibers have an antimicrobial coating.

31. A portable water purification unit according to claim 1, wherein the water purification unit comprises filter medium with positively charged nanoalumina fibers for blocking microbes for traversing the unit.

32. A portable water purification unit according to claim 29, wherein the unit with the medium containing positively charged nanoalumina has an antimicrobial coating.

33. A portable water purification unit according to claim 1, wherein the water purification unit has a module with an iodine releasing resin for killing microbes in water.

34. A portable water purification unit according to claim 33, wherein the water purification unit has a module with an iodine scavenger downstream of the iodine compartment.

35. A portable water purification unit according to claim 34, wherein the unit has a coarse filter at the first end for filtering coarse particles from the water flowing through the unit, a fine filter downstream of the coarse filter.

36. A portable water purification unit according to claim 35, wherein iodine scavenger is a strong anionic resin.

37. A portable water purification unit according to claim 36, wherein the strong anionic resin is Dowex™ Marathon™ A.

38. A portable water purification unit according to claim 36, wherein the unit has a module with granular activated carbon downstream of the strong anionic resin.

39. A portable water purification unit according to claim 34, wherein a void space is provided between a module with iodine releasing resin and a module with an iodine scavenging resin, the void space having a volume configured for substantial extension of the reaction time between the iodine and water contaminants.

40. A portable water purification unit according to claim 34, wherein the unit has a strong anionic resin in a module downstream of the iodine releasing resin module, the strong anionic resin being an iodine scavenger configured for releasing chlorine during iodine scavenging, the amount of released chlorine being configured for oxidation of trivalent arsenide to pentavalent arsenide.

41. A portable water purification unit according to claim 40, wherein the iodine scavenger resin is a strong base anion exchange resin.

42. A portable water purification unit according to claim 41, wherein the strong base anion exchange resin comprises activated alumina.

43. A portable water purification unit according to claim 41, wherein the strong base anion exchange resin comprises ferric oxide.

44. A portable water purification unit the unit according to claim 38, wherein the unit has a further downstream module with a arsenide removal resin configured for removal of arsenide from the water.

45. A portable water purification unit the unit according to claim 38 wherein the unit has a module with activated carbon downstream of the iodine scavenging resin.

46. A portable water purification unit the unit according to claim 45, wherein the activated carbon is silver loaded.

47. A portable water purification unit according to claim 1 containing an ultra violet (UV) lamp.

48. A portable water purification unit according to claim 47, wherein the UV lamp is an LED.

49. A portable water purification unit according to claim 1 containing an electronic circuit configured for indicating whether the cleaning process is satisfactory within predetermined levels.

50. A portable water purification unit according to claim 49, wherein the electronic circuit is configured to measure conduction through the water, the conduction being governed by the contamination of the water.

51. A portable water purification unit according to claim 50, comprising a solar cell for powering the electronic circuit.

52. A production method for a portable water purification unit according to claim 1, the method comprising,
providing a mould with an inside cavity in the form of a tubular module,
providing a band of mesh material
guiding the mesh material into an injection mould,
closing the mould,
injecting polymer to form the first tubular module and overmoulding a rim part of the mesh with the polymer,
filling dedicated media into the first module,
closing the open end of the module with the mesh of another module by stacking the other module in extension of the first module.
